(19) United States
(12) Patent Application Publication
(10) Pub. No.: US 2026/0305530 A1
(43) Pub. Date: Oct. 8, 2026

(54) LAWN MOWER

(71) Applicant: NEXLAWN INTELLIGENT TECHNOLOGY (SUZHOU) CO., LTD., Suzhou (CN)

(72) Inventors: Fei Li, Suzhou (CN); Jiayu Gu, Suzhou (CN)

(21) Appl. No.: 19/234,437

(22) Filed: Jun. 11, 2025

(30) Foreign Application Priority Data
Apr. 3, 2025 (CN) 202510421480.7

(51) Int. Cl. A01D 34/81; A01D 101/00

(52) U.S. Cl. CPC A01D 34/81; A01D 2101/00

(57) ABSTRACT

A lawn mower is provided. The lawn mower includes a gripping portion provided with a toothed structure having multiple tooth units. A first extension direction of each of the tooth units forms an included angle of 75° to 105° with a length direction of the gripping portion and is not perpendicular to a traveling direction; the tooth units are spaced apart along the length direction of the gripping portion, and projections of any two adjacent tooth units on a plane perpendicular to the length direction of the gripping portion at least partially overlap. There is a first spacing between any two adjacent tooth units along the gripping portion. A minimum gap between orthographic projections of any two adjacent tooth units on a plane perpendicular to the traveling direction forms a second spacing. A ratio of the first spacing to the second spacing is greater than 1 and less than 5.

### CROSS-REFERENCE TO RELATED APPLICATIONS

The present application claims priority to Chinese Patent Application No. 202510421480.7, filed with the China National Intellectual Property Administration on Apr. 3, 2025 and entitled “LAWN MOWER”, which is incorporated herein by reference in its entirety.

### TECHNICAL FIELD

The present application relates but is not limited to the technical field of lawn mowers, and in particular, to a lawn mower.

### BACKGROUND

Lawn mowers can be used in various lawn maintenance settings such as home gardens, parks, green spaces, golf courses, and the like for mowing and trimming lawns.

A lawn mower includes a handle structure and a grass-combing mechanism separately installed on the lawn mower's body as two components. When users need to move the lawn mower, the grass-combing mechanism, as a separately installed component, can easily affect the lawn mower's overall center of gravity due to its positional arrangement, thereby affecting users'gripping comfort and the lawn mower's portability. Additionally, there is a gap between the installed grass-combing mechanism and handle structure, and debris such as mud and sand kicked up during mowing can easily accumulate in and clog the gap. Such accumulated debris is difficult to clean. Before lifting the handle structure each time, users must clear the accumulated debris between the handle structure and the grass-combing mechanism, which is cumbersome and inefficient. Moreover, frequent cleaning may easily cause wear to the handle structure and the grass-combing mechanism, while prolonged neglect of cleaning may cause corrosion to them.

### SUMMARY

In order to solve the above technical problems, a lawn mower with the advantages of an easy-to-grip handle, reduced accumulation of debris such as mud and sand at the handle, and a long service life for both the handle and a toothed structure, is provided according to embodiments of the present application. The objectives of the present application are achieved by the following technical solutions.

In a first aspect, a lawn mower is provided according to an embodiment of the present application. The lawn mower is capable of traveling along a traveling direction on a traveling surface and includes a body, where the body includes a front-side portion and a rear-side portion along the traveling direction and is provided with a through-hole arranged at the rear-side portion of the body, and a gripping portion is formed between the through-hole and an edge of the rear-side portion of the body; the gripping portion is a strip-shaped member, and a toothed structure including multiple tooth units is arranged on a side of the gripping portion facing towards the traveling surface, where a projection of each of the tooth units on the traveling surface is strip-shaped with a first extension direction, an included angle between the first extension direction and a length direction of the gripping portion is greater than or equal to 75° and less than or equal to 105°, and an included angle between the first extension direction and the traveling direction is unequal to 90°; and the multiple tooth units are spaced apart along the length direction of the gripping portion, and projections of any two adjacent ones of the tooth units on a plane perpendicular to the length direction of the gripping portion at least partially overlap; and there is a first spacing D1 between the any two adjacent ones of the tooth units along the length direction of the gripping portion, and a minimum gap between orthographic projections of the any two adjacent ones of the tooth units on a plane perpendicular to the traveling direction forms a second spacing D2, where a ratio of the first spacing D1 to the second spacing D2 is greater than 1 and less than 5.

According to a technical solution of the present application, the body of the lawn mower includes a front-side portion and a rear-side portion which is provided with a through-hole, and a gripping portion for users to grip is formed between the through-hole and an edge of the rear-side portion. The toothed structure including multiple tooth units is arranged on the side of the gripping portion facing towards the traveling surface. These tooth units can function as grass-combing teeth and form channels for users to grip, thereby enhancing stability during users' gripping of the gripping portion. Since the toothed structure is integrated into the gripping portion, the toothed structure and the gripping portion can be arranged on the body as a whole, enhancing structural integrity and optimizing the centers of gravity thereof; additionally, it is not easy for debris such as mud and sand to accumulate between the toothed structure and the gripping portion, reducing wear and corrosion caused by accumulated debris to the tooth units and the gripping portion. This configuration not only extends the service lives of both the tooth units and the gripping portion but also saves time for clearing the accumulated debris, thereby improving the user experience of the lawn mower. Each of the tooth units extends along the first extension direction, and the included angle between the first extension direction and the length direction of the gripping portion falls within a reasonable range. The extension direction of the tooth units aligns with the natural finger placement when users grip the gripping portion, thereby facilitating gripping by the users and the forming of an appropriate included angle between the extension direction of the tooth units and the traveling direction, and improving grass-combing performance. The ratio of the first spacing D1 to the second spacing D2 being greater than and closer to 1 indicates that the extension direction of the tooth units is closer to the traveling direction X, facilitating the passage of grass through gaps between adjacent tooth units. In this case, grass-combing performance is significantly improved. Therefore, if users prioritize gripping comfort over high-efficiency grass combing, the ratio can be set to a value greater than but not close to 1 by adjusting the length extension direction of the gripping portion. This is because the ratio being less than or equal to 1 would cause the tooth units to obstruct rather than support users' fingers when inserted for gripping and carrying. Users would then need to adjust their finger positioning to accommodate the tooth units' extension, and prolonged gripping under the influence of the body's weight could lead to nerve compression in fingers due to pressure from the tooth units.

The ratio of the first spacing D1 to the second spacing D2 being less than and closer to 5 indicates larger gaps between adjacent tooth units, facilitating finger insertion and significantly improving the user experience. Therefore, if users prioritize grass-combing performance over gripping comfort, the ratio can be set to a value less than but not close to 5 by adjusting the length extension direction of the gripping portion. This is because the ratio being greater than or equal to 5 would cause the tooth units to nearly block the entrance of the grass-combing channel, preventing proper grass combing during traveling and causing poor grass-combing performance. In summary, the ratio of the first spacing D1 to the second spacing D2 being greater than 1 and less than 5 can facilitate not only the passage of grass through gaps between adjacent tooth units to enhance grass-combing performance but also comfortable finger insertion for users to meet users' demand for gripping comfort.

In some embodiments of the present application, a first included angle is formed between a length direction of the strip-shaped member and the traveling direction, and the first included angle is greater than or equal to 30° and less than or equal to 60°.

According to a technical solution of the present application, the first included angle between the length direction of the strip-shaped member and the traveling direction is set within a reasonable range, not only meeting the arrangement requirements of the gripping portion at different positions on the body but also facilitating users to lift the lawn mower through the gripping portion.

In some embodiments of the present application, a side of the gripping portion facing towards the through-hole is configured as a first gripping surface; a grass-combing channel is formed between the any two adjacent ones of the tooth units; the grass-combing channel extends in a direction perpendicular to the length direction of the gripping portion; and the side of the gripping portion facing towards the traveling surface is configured as a second gripping surface, and the second gripping surface is connected to the first gripping surface.

According to a technical solution of the present application, a side of the gripping portion corresponding to the through-hole is configured as a first gripping surface, which is relatively flat and convenient for users to grip; a grass-combing channel is formed between the any two adjacent ones of the tooth units, facilitating the passage of grass; the grass-combing channel extends in a direction perpendicular to the length direction of the gripping portion, facilitating users to insert their fingers into the grass-combing channel when they grip the gripping portion; and a side of the gripping portion corresponding to the grass-combing channel is configured as a second gripping surface, and the second gripping surface is connected to the first gripping surface, thereby facilitating users to grip the gripping portion, improving the fit between users' palms and fingers and the gripping portion, and enhancing gripping performance.

In some embodiments of the present application, the tooth units are integrally formed with the gripping portion.

According to a technical solution of the present application, the integrally formed tooth units and gripping portion not only enhance structural integrity and strength but also optimizes centers of gravity of both the tooth units and the gripping portion; additionally, the tooth units and the gripping portion do not require separate installation onto the body, making assembly, disassembly, and maintenance more convenient; furthermore, since there is no assembly gap between the integrally formed tooth units and gripping portion, debris is hard to accumulate, reducing wear and corrosion caused by accumulated debris to the tooth units and the gripping portion, thereby extending their service lives and saving time for clearing the accumulated debris.

In some embodiments of the present application, the lawn mower further includes a cutting assembly, and relative to the cutting assembly, the gripping portion is located at a rear side of the body.

According to a technical solution of the present application, relative to the cutting assembly, the gripping portion is located at the rear side of the body so that the tooth units on the gripping portion can comb through the cut grass, thereby making the lawn more even and aesthetically pleasing and enhancing the aesthetic effect created by the lawn mower on the lawn.

In some embodiments of the present application, along a direction parallel to the traveling surface and perpendicular to the traveling direction, the body includes a first side portion and a second side portion; the number of the gripping portion is two; and the two gripping portions are respectively located at the first and second side portions of the body.

According to a technical solution of the present application, the two gripping portions are respectively located at the first and second side portions of the body, enabling users to choose one or both for operation as needed and enhancing operational convenience; additionally, the tooth units on the two gripping portions can separately comb through the grass passing through the first and second side portions, thereby improving grass-combing uniformity.

In some embodiments of the present application, the two gripping portions are symmetrically arranged about a central axis of the body along the traveling direction.

According to a technical solution of the present application, the two symmetrically arranged gripping portions optimize the center of gravity distribution of the body and enable users to apply a force evenly, making it easier to lift the lawn mower; additionally, since the gripping portions are symmetrically arranged, the tooth units thereon are also arranged symmetrically about the central axis, ensuring that the two toothed structures can achieve consistent grass-combing performance.

In a second aspect, a lawn mower is provided according to an embodiment of the present application. The lawn mower is capable of traveling along a traveling direction on a traveling surface and includes a body, where the body includes a front-side portion and a rear-side portion along the traveling direction and is provided with a through-hole arranged at the rear-side portion of the body, and a gripping portion is formed between the through-hole and an edge of the rear-side portion of the body; a toothed structure is arranged on a side of the gripping portion facing towards the traveling surface, and the gripping portion is a strip-shaped member; and a first included angle is formed between a length direction of the strip-shaped member and the traveling direction, and the first included angle is greater than or equal to 30° and less than or equal to 60°.

According to a technical solution of the present application, the body of the lawn mower includes a front-side portion and a rear-side portion which is provided with a through-hole, and a gripping portion for users to grip is formed between the through-hole and an edge of the rear-side portion. The toothed structure including multiple tooth units is arranged on the side of the gripping portion facing towards the traveling surface. These tooth units can function as grass-combing teeth and form channels for users to grip, thereby enhancing stability during users' gripping of the gripping portion. Since the toothed structure is integrated into the gripping portion, the toothed structure and the gripping portion can be arranged on the body as a whole, enhancing structural integrity and optimizing the centers of gravity thereof; additionally, it is not easy for debris such as mud and sand to accumulate between the toothed structure and the gripping portion, reducing wear and corrosion caused by accumulated debris to the tooth units and the gripping portion. This configuration not only extends the service lives of both the tooth units and the gripping portion but also saves time for clearing the accumulated debris, thereby improving the user experience of the lawn mower. The first included angle between the length direction of the strip-shaped member and the traveling direction is set within a reasonable range, not only meeting the arrangement requirements of the gripping portion at different positions on the body but also facilitating users to lift the lawn mower through the gripping portion.

In some embodiments of the present application, the toothed structure includes multiple tooth units; a projection of each of the tooth units on the traveling surface is strip-shaped with a first extension direction; an included angle between the first extension direction and the length direction of the gripping portion is greater than or equal to 75° and less than or equal to 105°, and an included angle between the first extension direction and the traveling direction is unequal to 90°; and the multiple tooth units are spaced apart along the length direction of the gripping portion, and projections of any two adjacent ones of the tooth units on a plane perpendicular to the length direction of the gripping portion at least partially overlap.

According to a technical solution of the present application, each of the tooth units extends along the first extension direction, and the included angle between the first extension direction and the length direction of the gripping portion falls within a reasonable range. The extension direction of the tooth units aligns with the natural finger placement when users grip the gripping portion, thereby facilitating gripping by users and the forming of an appropriate included angle between the extension direction of the tooth units and the traveling direction, and improving grass-combing performance.

In some embodiments of the present application, there is a first spacing D1 between the any two adjacent ones of the tooth units along the length direction of the gripping portion, and a minimum gap between orthographic projections of the any two adjacent ones of the tooth units on a plane perpendicular to the traveling direction forms a second spacing D2, where a ratio of the first spacing D1 to the second spacing D2 is greater than 1 and less than 5.

According to a technical solution of the present application, the ratio of the first spacing between the any two adjacent ones of the tooth units to the second spacing is set within a reasonable range, facilitating not only the passage of grass through gaps between adjacent tooth units to enhance grass-combing performance but also leaving enough gaps for finger insertion to improve users' experience when gripping the gripping portion.

In some embodiments of the present application, a side of the gripping portion facing towards the through-hole is configured as a first gripping surface; a grass-combing channel is formed between the any two adjacent ones of the tooth units; the grass-combing channel extends in a direction perpendicular to the length direction of the gripping portion; and the side of the gripping portion facing towards the traveling surface is configured as a second gripping surface, and the second gripping surface is connected to the first gripping surface.

According to a technical solution of the present application, a side of the gripping portion corresponding to the through-hole is configured as a first gripping surface, which is relatively flat and convenient for users to grip; a grass-combing channel is formed between the any two adjacent ones of the tooth units, facilitating the passage of grass; the grass-combing channel extends in a direction perpendicular to the length direction of the gripping portion, facilitating users to insert their fingers into the grass-combing channel when they grip the gripping portion; and a side of the gripping portion corresponding to the grass-combing channel is configured as a second gripping surface, and the second gripping surface is connected to the first gripping surface, thereby facilitating users to grip the gripping portion, improving the fit between users' palms and fingers and the gripping portion, and enhancing gripping performance.

In some embodiments of the present application, the tooth units are integrally formed with the gripping portion.

According to a technical solution of the present application, the integrally formed tooth units and gripping portion not only enhance structural integrity and strength but also optimizes centers of gravity of both the tooth units and the gripping portion; additionally, the tooth units and the gripping portion do not require separate installation onto the body, making assembly, disassembly, and maintenance more convenient; furthermore, since there is no assembly gap between the integrally formed tooth units and gripping portion, debris is hard to accumulate, reducing wear and corrosion caused by accumulated debris to the tooth units and the gripping portion, thereby extending their service lives and saving time for clearing the accumulated debris.

In some embodiments of the present application, the lawn mower further includes a cutting assembly, and relative to the cutting assembly, the gripping portion is located at a rear side of the body.

According to a technical solution of the present application, relative to the cutting assembly, the gripping portion is located at the rear side of the body so that the tooth units on the gripping portion can comb through the cut grass, thereby making the lawn more even and aesthetically pleasing and enhancing the aesthetic effect created by the lawn mower on the lawn.

In some embodiments of the present application, along a direction parallel to the traveling surface and perpendicular to the traveling direction, the body includes a first side portion and a second side portion; the number of the gripping portion is two; and the two gripping portions are respectively located at the first and second side portions of the body.

According to a technical solution of the present application, the two gripping portions are respectively located at the first and second side portions of the body, enabling users to choose one or both for operation as needed and enhancing operational convenience; additionally, the tooth units on the two gripping portions can separately comb through the grass passing through the first and second side portions, thereby improving grass-combing uniformity.

In some embodiments of the present application, the two gripping portions are symmetrically arranged about a central axis of the body along the traveling direction.

According to a technical solution of the present application, the two symmetrically arranged gripping portions optimize the center of gravity distribution of the body and enable users to apply a force evenly, making it easier to lift the lawn mower; additionally, since the gripping portions are symmetrically arranged, the tooth units thereon are also arranged symmetrically about the central axis, ensuring that the two toothed structures can achieve consistent grass-combing performance.

In a third aspect, a lawn mower is provided according to an embodiment of the present application. The lawn mower is capable of traveling along a traveling direction on a traveling surface and includes a body, where the body includes a front-side portion and a rear-side portion along the traveling direction and is provided with a through-hole arranged at the rear-side portion of the body, and a gripping portion is formed between the through-hole and an edge of the rear-side portion of the body; the gripping portion is a strip-shaped member, and a toothed structure including multiple tooth units is arranged on a side of the gripping portion facing towards the traveling surface, where a projection of each of the tooth units on the traveling surface is strip-shaped with a first extension direction, an included angle between the first extension direction and a length direction of the gripping portion is greater than or equal to 75° and less than or equal to 105°, and an included angle between the first extension direction and the traveling direction is unequal to 90°, and the multiple tooth units are spaced apart along the length direction of the gripping portion, and projections of any two adjacent ones of the tooth units on a plane perpendicular to the length direction of the gripping portion at least partially overlap; and an included angle between the length direction of the gripping portion and the traveling direction is greater than 0°.

According to a technical solution of the present application, the body of the lawn mower includes a front-side portion and a rear-side portion which is provided with a through-hole, and a gripping portion for users to grip is formed between the through-hole and an edge of the rear-side portion. The toothed structure including multiple tooth units is arranged on the side of the gripping portion facing towards the traveling surface. These tooth units can function as grass-combing teeth and form channels for users to grip, thereby enhancing stability during users' gripping of the gripping portion. Since the toothed structure is integrated into the gripping portion, the toothed structure and the gripping portion can be arranged on the body as a whole, enhancing structural integrity and optimizing the centers of gravity thereof; additionally, it is not easy for debris such as mud and sand to accumulate between the toothed structure and the gripping portion, reducing wear and corrosion caused by accumulated debris to the tooth units and the gripping portion. This configuration not only extends the service lives of both the tooth units and the gripping portion but also saves time for clearing the accumulated debris, thereby improving the user experience of the lawn mower. Each of the tooth units extends along the first extension direction, and the included angle between the first extension direction and the length direction of the gripping portion falls within a reasonable range. The extension direction of the tooth units aligns with the natural finger placement when users grip the gripping portion, thereby facilitating gripping by the users and the forming of an appropriate included angle between the extension direction of the tooth units and the traveling direction, and improving grass-combing performance. The included angle of a certain degree formed between the length direction of the gripping portion and the traveling direction can prevent poor or ineffective grass combing that would occur if the gripping portion were arranged parallel to the traveling direction.

In some embodiments of the present application, there is a first spacing D1 between the any two adjacent ones of the tooth units along the length direction of the gripping portion, and a minimum gap between orthographic projections of the any two adjacent ones of the tooth units on a plane perpendicular to the traveling direction forms a second spacing D2, where a ratio of the first spacing D1 to the second spacing D2 is greater than 1 and less than 5.

According to a technical solution of the present application, the ratio of the first spacing D1 to the second spacing D2 being greater than and closer to 1 indicates that the extension direction of the tooth units is closer to the traveling direction X, facilitating the passage of grass through gaps between adjacent tooth units. In this case, grass-combing performance is significantly improved. Therefore, if users prioritize gripping comfort over high-efficiency grass combing, the ratio can be set to a value greater than but not close to 1 by adjusting the length extension direction of the gripping portion. This is because the ratio being less than or equal to 1 would cause the tooth units to obstruct rather than support users' fingers when inserted for gripping and carrying. Users would then need to adjust their finger positioning to accommodate the tooth units' extension, and prolonged gripping under the influence of the body's weight could lead to nerve compression in fingers due to pressure from the tooth units.

The ratio of the first spacing D1 to the second spacing D2 being less than and closer to 5 indicates larger gaps between adjacent tooth units, facilitating finger insertion and significantly improving the user experience. Therefore, if users prioritize grass-combing performance over gripping comfort, the ratio can be set to a value less than but not close to 5 by adjusting the length extension direction of the gripping portion. This is because the ratio being greater than or equal to 5 would cause the tooth units to nearly block the entrance of the grass-combing channel, preventing proper grass combing during traveling and causing poor grass-combing performance. In summary, the ratio of the first spacing D1 to the second spacing D2 being greater than 1 and less than 5 can facilitate not only the passage of grass through gaps between adjacent tooth units to enhance grass-combing performance but also comfortable finger insertion for users to meet users' demand for gripping comfort.

In a fourth aspect, a lawn mower is provided according to an embodiment of the present application. The lawn mower is capable of traveling along a traveling direction on a traveling surface and includes a body, where the body includes a front-side portion and a rear-side portion along the traveling direction and is provided with a through-hole arranged at the rear-side portion of the body, and a gripping portion is formed between the through-hole and an edge of the rear-side portion of the body; the gripping portion is a strip-shaped member, and a toothed structure including multiple tooth units is arranged on a side of the gripping portion facing towards the traveling surface, and multiple tooth units are spaced apart along a length direction of the gripping portion; an included angle between the length direction of the gripping portion and the traveling direction is greater than 0°, a minimum gap is formed between any two adjacent ones of the tooth units, the any two adjacent ones of the tooth units have first limiting surfaces arranged opposite to each other at both sides of the minimum gap, and a minimum spacing between the first limiting surfaces of the any two adjacent ones of the tooth units along the length direction of the gripping portion is a first spacing D1; and a minimum gap between orthographic projections of the any two adjacent ones of the tooth units on a plane perpendicular to the traveling direction forms a second spacing D2 of greater than 0, where a ratio of the first spacing D1 to the second spacing D2 is greater than 1 and less than 5.

According to a technical solution of the present application, the body of the lawn mower includes a front-side portion and a rear-side portion which is provided with a through-hole, and a gripping portion for users to grip is formed between the through-hole and an edge of the rear-side portion. The toothed structure including multiple tooth units is arranged on the side of the gripping portion facing towards the traveling surface. These tooth units can function as grass-combing teeth and form channels for users to grip, thereby enhancing stability during users' gripping of the gripping portion. Since the toothed structure is integrated into the gripping portion, the toothed structure and the gripping portion can be arranged on the body as a whole, enhancing structural integrity and optimizing the centers of gravity thereof; additionally, it is not easy for debris such as mud and sand to accumulate between the toothed structure and the gripping portion, reducing wear and corrosion caused by accumulated debris to the tooth units and the gripping portion. This configuration not only extends the service lives of both the tooth units and the gripping portion but also saves time for clearing the accumulated debris, thereby improving the user experience of the lawn mower. The first limiting surfaces are flat or curved, which is convenient for providing support for users' fingers and prevents the grass-facing limiting surfaces of the tooth units from being too narrow or sharp and potentially injuring users' hands; additionally, the smooth and elongated channel formed between the first limiting surfaces facilitates the passage of grass, thereby improving grass-combing performance. The included angle of a certain degree formed between the length direction of the gripping portion and the traveling direction can prevent poor or ineffective grass combing that would occur if the gripping portion were arranged parallel to the traveling direction.

The ratio of the first spacing D1 to the second spacing D2 being greater than and closer to 1 indicates that the extension direction of the tooth units is closer to the traveling direction X, facilitating the passage of grass through gaps between adjacent tooth units. In this case, grass-combing performance is significantly improved. Therefore, if users prioritize gripping comfort over high-efficiency grass combing, the ratio can be set to a value greater than but not close to 1 by adjusting the length extension direction of the gripping portion. This is because the ratio being less than or equal to 1 would cause the tooth units to obstruct rather than support users' fingers when inserted for gripping and carrying. Users would then need to adjust their finger positioning to accommodate the tooth units' extension, and prolonged gripping under the influence of the body's weight could lead to nerve compression in fingers due to pressure from the tooth units.

The ratio of the first spacing D1 to the second spacing D2 being less than and closer to 5 indicates larger gaps between adjacent tooth units, facilitating finger insertion and significantly improving the user experience. Therefore, if users prioritize grass-combing performance over gripping comfort, the ratio can be set to a value less than but not close to 5 by adjusting the length extension direction of the gripping portion. This is because the ratio being greater than or equal to 5 would cause the tooth units to nearly block the entrance of the grass-combing channel, preventing proper grass combing during traveling and causing poor grass-combing performance. In summary, the ratio of the first spacing D1 to the second spacing D2 being greater than 1 and less than 5 can facilitate not only the passage of grass through gaps between adjacent tooth units to enhance grass-combing performance but also comfortable finger insertion for users to meet users' demand for gripping comfort.

In some embodiments of the present application, a first included angle is formed between a length direction of the strip-shaped member and the traveling direction, and the first included angle is greater than or equal to 30° and less than or equal to 60°.

According to a technical solution of the present application, the first included angle between the length direction of the strip-shaped member and the traveling direction is set within a reasonable range, not only meeting the arrangement requirements of the gripping portion at different positions on the body but also facilitating users to lift the lawn mower through the gripping portion.

In some embodiments of the present application, a side of the gripping portion facing towards the through-hole is configured as a first gripping surface; a grass-combing channel is formed between the any two adjacent ones of the tooth units; the grass-combing channel extends in a direction perpendicular to the length direction of the gripping portion; and the side of the gripping portion facing towards the traveling surface is configured as a second gripping surface, and the second gripping surface is connected to the first gripping surface.

According to a technical solution of the present application, a side of the gripping portion corresponding to the through-hole is configured as a first gripping surface, which is relatively flat and convenient for users to grip; a grass-combing channel is formed between the any two adjacent ones of the tooth units, facilitating the passage of grass; the grass-combing channel extends in a direction perpendicular to the length direction of the gripping portion, facilitating users to insert their fingers into the grass-combing channel when they grip the gripping portion; and a side of the gripping portion corresponding to the grass-combing channel is configured as a second gripping surface, and the second gripping surface is connected to the first gripping surface, thereby facilitating users to grip the gripping portion, improving the fit between users' palms and fingers and the gripping portion, and enhancing gripping performance.

### BRIEF DESCRIPTION OF THE DRAWINGS

FIG. 1 is a schematic structural diagram of a side of a lawn mower facing towards a traveling surface according to an embodiment of the present application;

FIG. 2 is a schematic diagram of a partial structure of a rear-side portion of a lawn mower according to an embodiment of the present application;

FIG. 3 is a schematic diagram of a first spacing and a second spacing of a lawn mower according to an embodiment of the present application;

FIG. 4 is a schematic structural diagram of a first gripping surface and a second gripping surface of a lawn mower according to an embodiment of the present application; and

FIG. 5 is a schematic arrangement diagram of multiple gripping portions of a lawn mower according to an embodiment of the present application.

### REFERENCE SIGNS

100: body; 110: front-side portion; 120: rear-side portion; 130: through-hole; 140: gripping portion; 141: first gripping surface; 142: second gripping surface; 150: toothed structure; 151: tooth unit; 152: grass-combing channel; 160: first side portion; 170: second side portion; 200: cutting assembly; D1: first spacing; D2: second spacing; α: first included angle; β: second included angle; γ: third included angle; L: central axis; M: traveling surface; X: traveling direction; F1: first extension direction; and F2: length direction of the gripping portion.

### DETAILED DESCRIPTION

In order to make the objectives, technical solutions, and advantages of the embodiments of the present application clearer, the technical solutions of the present application will be further described in detail below with reference to the accompanying drawings in the embodiments of the present application. The following embodiments are intended to illustrate the present application rather than to limit the scope thereof.

In the embodiments of the present application, the terms “first” and “second” are only intended for the purpose of description and should not be construed as indicating or implying their relative importance or implying the quantity of technical features indicated. Therefore, a feature limited by “first” or “second” may explicitly or implicitly include one or more of such features. In the description of the embodiments of the present application, unless otherwise specified, “a plurality of” or “multiple” refers to two or more.

Additionally, in the embodiments of the present application, the directional terms such as “up”, “down”, “left”, and “right” are defined relative to the orientation of the components as illustrated in the accompanying drawings. It should be understood that these directional terms are relative concepts used for descriptive and clarifying purposes, and may change accordingly based on changes in the orientation of the components illustrated in the accompanying drawings.

In the embodiments of the present application, unless otherwise expressly specified and defined, the term “connection” should be understood in a broad sense. For example, a “connection” may be a fixed connection, a detachable connection, or an integral connection; or it may be a direct connection or an indirect connection via an intermediate medium.

In the embodiments of the present application, the terms “comprise”, “include”, or any other variants thereof used herein are intended to encompass non-exclusive inclusion so that a process, method, article, or apparatus that includes a series of elements not only includes these elements but also may further include other elements not expressly listed, or elements inherent to such process, method, article, or apparatus. Unless more limitations are stated, an element defined by the phrase “including a . . . ” does not exclude the presence of additional identical elements in the process, method, article, or apparatus that includes the element.

In the embodiments of the present application, the terms such as “exemplary” or “for example” are used to indicate an example, instance, or illustration. In the embodiments of the present application, any embodiment or design solution described as “exemplary” or “for example” should not be construed as being preferred or advantageous over other embodiments or design solutions. To be exact, the terms such as “exemplary” or “for example” are intended to present related concepts in a specific manner.

A lawn mower is provided according to embodiments of the present application. The lawn mower can be used in various lawn maintenance settings such as home gardens, parks, green spaces, golf courses, and the like for mowing and trimming lawns, and may be driven by an internal combustion engine, electricity, hybrid power, or other forms.

In some technical solutions, a lawn mower includes a handle structure and a grass-combing mechanism, where the grass-combing mechanism is configured to comb grass to facilitate cutting by the lawn mower, or to comb the cut lawn to make it neater and more aesthetically pleasing; and the handle structure is for users to grip so that the users can lift and carry the lawn mower. The handle structure and the grass-combing mechanism are separately installed on the lawn mower's body as two components. The installation process is relatively complex and requires consideration of the relationship between the centers of gravity of the combing mechanism and the lawn mower to achieve better a gripping experience, and the structural connection between the handle structure and the grass-combing mechanism after installation is relatively loose, leading to a gap between the two components. As a result, debris such as mud and sand kicked up during mowing can easily accumulate in and clog the gap. Such accumulated debris is difficult to clean. Before lifting the handle structure each time, users must clear the accumulated debris between the handle structure and the grass-combing mechanism, which is cumbersome and inefficient. Moreover, frequent cleaning may easily cause wear to the handle structure and the grass-combing mechanism, while prolonged neglect of cleaning may cause corrosion to them.

Before providing further detailed description of the embodiments of the present application, it is necessary to clarify the nouns and terms referenced in these embodiments, which should be interpreted according to the following definitions.
1) Traveling surface: a surface that supports and guides the traveling of the lawn mower, and contacts the lawn mower's traveling mechanism. For example, when the lawn mower operates on a lawn, the ground surface of the lawn may be considered the traveling surface. It should be noted that the traveling surface may be either a horizontal plane or inclined relative to the horizontal plane.
2) Traveling direction: a movement direction of the lawn mower along the traveling surface, which may also be understood as a direction from a rear-side portion toward a front-side portion of the lawn mower. During mowing operations, the front-side portion faces to-be-cut grass while the rear-side portion faces already-cut grass; in other words, when the lawn mower is traveling, its front-side portion advances across the traveling surface before the rear-side portion.
3) Through-hole: a through-hole formed in a structural member, including two openings located on different surfaces of the structural member, typically on opposite side surfaces. The extending axis of the through-hole is linear or approximately linear, maintaining perpendicular or approximately perpendicular to the surfaces where the openings are located.
4) Length direction: the primary extension direction of a structural member in space, where the dimension along the length direction exceeds those along other extension directions of the structural member. For example, the length direction of a cuboid structural member is parallel to its longest edge; and for example, the length direction of a cylindrical structural member is parallel to its central axis.
5) Spaced apart: multiple structural members are arranged sequentially with gaps between two adjacent ones, rather than being tightly fitted together. For example, multiple tooth units of a toothed structure may be arranged in a linear array with gaps between two adjacent ones.
6) Central axis: an axis passing through the geometric center of a structural member. Taking the lawn mower's body as an example, the lawn mower contains a central axis parallel to the traveling direction and a central axis perpendicular to the traveling direction, where the central axis perpendicular to the traveling direction may be parallel to or perpendicular to the traveling surface.

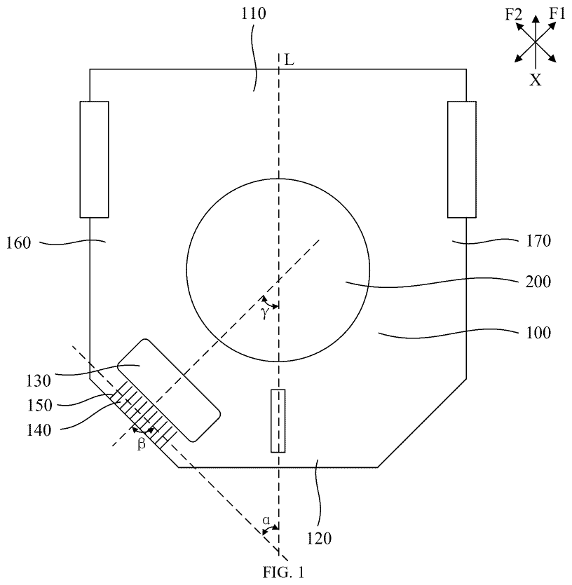

Referring to FIGS. 1, 2, and 3, the lawn mower provided by the embodiments of the present application is capable of traveling along a traveling direction X on a traveling surface M and includes a body 100. The body 100 includes a front-side portion 110 and a rear-side portion 120 along the traveling direction X and is provided with a through-hole 130 arranged at the rear-side portion 120 of the body 100. A gripping portion 140 is formed between the through-hole 130 and an edge of the rear-side portion 120 of the body 100. The gripping portion 140 is a strip-shaped member, and a toothed structure 150 including multiple tooth units 151 is arranged on a side of the gripping portion 140 facing towards the traveling surface M. A projection of each of the tooth units 151 on the traveling surface M is strip-shaped with a first extension direction F1, an included angle between the first extension direction F1 and a length direction of the gripping portion 140 is greater than or equal to 75° and less than or equal to 105°, and an included angle between the first extension direction F1 and the traveling direction X is unequal to 90°. The multiple tooth units 151 are spaced apart along the length direction of the gripping portion 140, and projections of any two adjacent ones of the tooth units 151 on a plane perpendicular to the length direction of the gripping portion 140 at least partially overlap. There is a first spacing D1 between the any two adjacent ones of the tooth units 151 along the length direction of the gripping portion 140, and a minimum gap between orthographic projections of the any two adjacent ones of the tooth units 151 on a plane perpendicular to the traveling direction X forms a second spacing D2, where a ratio of the first spacing D1 to the second spacing D2 is greater than 1 and less than 5.

In an embodiment of the present application, the body 100 may include a housing, a traveling mechanism, an energy supply mechanism, an electronic control assembly, etc., where the housing is configured to accommodate a cutting assembly 200 of the lawn mower; the traveling mechanism is arranged at the bottom of the housing and may include drive wheels, steering wheels, etc.; the energy supply mechanism and the electronic control assembly are arranged inside the housing for protection; the energy supply mechanism supplies energy to the cutting assembly 200, the traveling mechanism, etc.; and the electronic control assembly is configured to control the operation of the cutting assembly 200 and the traveling mechanism, and may also interact with users and communicate with external terminals.

In an embodiment of the present application, the front-side portion is arranged at the front side of the body 100 along the traveling direction X, and may be provided with structures such as an obstacle avoidance radar and an environmental monitoring camera; and the rear-side portion is arranged at the rear side of the body 100 along the traveling direction X, and may be provided with structures such as a navigation assembly and a charging assembly.

In an embodiment of the present application, the through-hole 130 may be a constant-diameter hole, tapered hole, or stepped hole, with its cross-sectional surface possibly being regularly shaped or irregularly shaped, such as circular, elliptical, race-track-shaped, triangular, rectangular, or trapezoidal. In some examples, the through-hole 130 is configured as an elliptical constant-diameter hole, with its longitudinal axis arranged perpendicular to the traveling surface M to facilitate the insertion of users' hands through the through-hole 130 to grip the gripping portion 140.

In an embodiment of the present application, the gripping portion 140 refers to a structure designed for manual gripping by users or mechanical gripping by robotic claws and is formed between the through-hole 130 and an edge of the rear-side portion 120 of the body 100. Specifically, both an inner wall on one side of the through-hole 130 and a surface of the body 100 that faces away from the inner wall of the through-hole 130 constitute the surface of the gripping portion 140. Taking manual gripping by users as an example, when a user inserts partial fingers through the through-hole 130, both fingers and palms encircle the gripping portion 140, enabling multi-directional force application on the gripping portion 140 so that the user can lift the lawn mower via the gripping portion 140.

In an embodiment of the present application, the strip-shaped member refers to an elongated structural member, which may be configured as a polyhedral structure, such as a right prism (with straight edges and planar faces) or a curved prism (with curved edges and arcuate surfaces), or as a cylinder or elliptical cylinder. In all configurations, the length direction of the strip-shaped member is parallel to the central axis of either the prism or the cylinder.

In an embodiment of the present application, the toothed structure 150 refers to a configuration including multiple concave portions and convex portions alternately arranged in sequence, where the convex portions may be referred to as tooth units 151, and the concave portions formed between two adjacent tooth units 151 may function as channels to enable the passage of other objects. In some examples, the toothed structure 150 serves as a grass-combing mechanism, where its concave portions form channels for the passage of grass, thereby achieving grass combing.

In an embodiment of the present application, the included angle between the first extension direction F1 and the length direction of the gripping portion 140 forms a second included angle β, and when the second included angle β approaches 90°, the extension direction of the tooth units 151 aligns more closely with the natural finger placement when users grip the gripping portion 140, thereby facilitating users to grip the gripping portion 140; conversely, the second included angle β approaching either 75° or 105° facilitates the forming of an appropriate included angle between the extension direction of the tooth units 151 and the traveling direction X, thereby improving grass-combing performance.

In an embodiment of the present application, the second included angle β is greater than or equal to 75° and less than or equal to 105°. In some examples, the second included angle β is greater than or equal to 75° and less than or equal to 90°, such as 75°, 80°, 85°, or 90°; in other examples, the second included angle β is greater than or equal to 85° and less than or equal to 95°, such as 85°, 90°, or 95°; in further examples, the second included angle β is greater than or equal to 90°and less than or equal to 105°, such as 90°, 95°, 100°, or 105°.

In an embodiment of the present application, the included angle between the first extension direction F1 and the traveling direction X forms a third included angle γ, where the third included angle γ is unequal to 90°. For example, the third included angle γ may be greater than or equal to 0° and less than 90°, such as 0°, 30°, 45°, 60°, or 75°; or, the third included angle γ may be greater than 90° and less than or equal to 180°, such as 105°, 120°, 150°, or 180°. It can be understood that when the third included angle γ is 0° or 180°, the extension direction of the tooth units 151 is parallel to the traveling direction X.

In an embodiment of the present application, the tooth units 151 may be configured as plate-shaped structures, rod-shaped structures, or similar structures, with the multiple tooth units 151 possibly having the same or different configurations, and the multiple tooth units 151 are spaced apart along the length direction of the gripping portion 140 at a consistent or variable spacing between any two adjacent ones of the tooth units 151. In some examples, the multiple tooth units 151 have the same configuration and are spaced apart at a consistent spacing.

In an embodiment of the present application, projections of any two adjacent ones of the tooth units 151 on a plane perpendicular to the length direction of the gripping portion 140 (i.e., viewed along the length direction of the gripping portion 140) at least partially overlap. It may be that one of the any two adjacent ones of the tooth units 151 is dimensionally smaller than the other; or, one of the any two adjacent ones of the tooth units 151 is closer to an edge of the body 100 while the other is closer to the through-hole 130, with the two not being completely staggered; still or, the any two adjacent ones of the tooth units 151 have the same configuration and dimensions with fully overlapping projections.

In an embodiment of the present application, the minimum gap between orthographic projections of the any two adjacent ones of the tooth units 151 specifically refers to the spacing between non-overlapping projections thereof when viewed along the traveling direction X. It may be also understood as, with the any two adjacent ones of the tooth units 151 each including a first end closer to the through-hole 130 and a second end closer to the edge of the body 100, the spacing between the first end of one tooth unit 151 and the second end of the other tooth unit 151 along the length direction of the gripping portion 140.

In an embodiment of the present application, a smaller ratio of the first spacing D1 to the second spacing D2 indicates that the extension direction of the tooth units 151 is more aligned with the traveling direction X, facilitating the passage of grass through gaps between adjacent tooth units 151 to enhance grass-combing performance; conversely, a larger ratio of the first spacing D1 to the second spacing D2 indicates wider gaps between adjacent tooth units 151, facilitating finger insertion for users to improve users' experience when gripping the gripping portion 140.

In an embodiment of the present application, the ratio of the first spacing D1 to the second spacing D2 is greater than 1 and less than 5. In some examples, the ratio of the first spacing D1 to the second spacing D2 is greater than 1 and less than or equal to 3, such as 1.1, 1.5, 2.0, 2.5, or 3; in other examples, the ratio of the first spacing D1 to the second spacing D2 is greater than or equal to 2 and less than or equal to 4, such as 2.0, 2.5, 3.0, 3.5, or 4.0; and in further examples, the ratio of the first spacing D1 to the second spacing D2 is greater than or equal to 3 and less than 5, such as 3.0, 3.5, 4.0, 4.5, or 4.9.

In a technical solution of the embodiments of the present application, the body 100 of the lawn mower includes a front-side portion 110 and a rear-side portion 120 which is provided with a through-hole 130, and a gripping portion 140 for users to grip is formed between the through-hole 130 and an edge of the rear-side portion 120. A toothed structure 150 including multiple tooth units 151 is arranged on a side of the gripping portion 140 facing towards the traveling surface M. The tooth units 151 can function as grass-combing teeth and form channels for users to grip, thereby enhancing stability during users' gripping of the gripping portion 140.

Since the toothed structure 150 is integrated into the gripping portion 140, the toothed structure 150 and the gripping portion 140 can be arranged on the body 100 as a whole, enhancing structural integrity, optimizing the centers of gravity thereof, and improving users' handling experience; additionally, it is not easy for debris such as mud and sand to accumulate between the toothed structure 150 and the gripping portion 140, reducing wear and corrosion caused by accumulated debris to the tooth units 151 and the gripping portion 140. This configuration not only extends the service lives of both the tooth units 151 and the gripping portion 140 but also saves time for clearing the accumulated debris, thereby improving the user experience of the lawn mower.

Each of the tooth units 151 extends along the first extension direction F1, and the included angle between the first extension direction F1 and the length direction of the gripping portion 140 falls within a reasonable range. The extension direction of the tooth units 151 aligns with the natural finger placement when users grip the gripping portion 140, thereby facilitating gripping by users and the forming of an appropriate included angle between the extension direction of the tooth units 151 and the traveling direction X, and improving grass-combing performance.

The ratio of the first spacing D1 between the any two adjacent ones of the tooth units 151 to the second spacing D2 is set within a reasonable range, facilitating not only the passage of grass through gaps between adjacent tooth units 151 to enhance grass-combing performance but also leaving enough gaps for finger insertion to improve users' experience when gripping the gripping portion 140.

Referring to FIG. 1, in some embodiments of the present application, a first included angle α is formed between the length direction of the strip-shaped member and the traveling direction X, and the first included angle α is greater than or equal to 30° and less than or equal to 60°.

In an embodiment of the present application, a user grips the strip-shaped member to apply a force to the lawn mower, where the direction of the interaction force between the user and the lawn mower is perpendicular to the length direction of the strip-shaped member. By setting the first included angle α within a reasonable range, the direction of the interaction force between the user and the lawn mower can pass through or approach the central area of the lawn mower. For example, an axis perpendicular to the strip-shaped member is the diagonal line of the body 100.

In an embodiment of the present application, the closer the first included angle α between the length direction of the strip-shaped member and the traveling direction X is to 30°, the closer the gripping portion 140 is to the central axis of the body 100 along the traveling direction X, and the closer the direction of the interaction force between a user and the lawn mower is to the rear-side portion 120 of the body 100, thereby helping shift the weight distribution of the lawn mower toward the rear and reducing drifting and slipping of the lawn mower during operation; when the first included angle α approaches 45°, the axis of the interaction force between the user and the lawn mower when the user grips the gripping portion 140 aligns more closely with the lawn mower's center of gravity, making it easier for the user to lift the lawn mower; and when the first included angle α is closer to 60°, the first extension direction F1 of the tooth units 151 remains perpendicular to the length direction of the gripping portion 140 while being more aligned with the traveling direction X, which not only facilitates the user to grip the gripping portion 140 but also improves the passage of grass through gaps between the tooth units 151.

In an embodiment of the present application, the first included angle α is greater than or equal to 30° and less than or equal to 60°. In some examples, the first included angle α is greater than or equal to 30° and less than or equal to 50°, such as 30°, 35°, 40°, 45°, or 50°; in other examples, the first included angle α is greater than or equal to 40° and less than or equal to 60°, such as 40°, 45°, 55°, or 60°.

In a technical solution of the embodiments of the present application, the first included angle α between the length direction of the strip-shaped member and the traveling direction X is set within a reasonable range, not only meeting the arrangement requirements of the gripping portion 140 at different positions on the body 100 but also facilitating users to lift the lawn mower through the gripping portion 140.

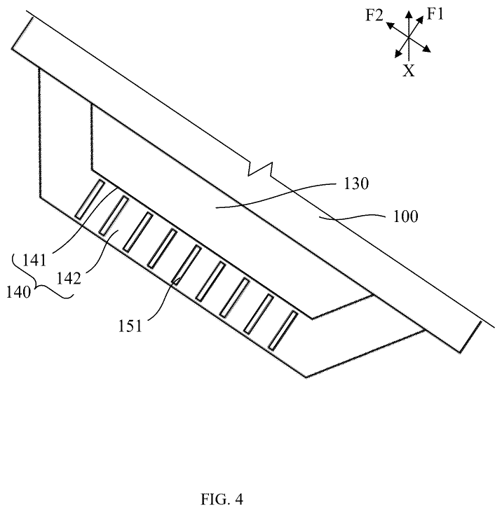

Referring to FIG. 4, in some embodiments of the present application, a side of the gripping portion 140 facing towards the through-hole 130 is configured as a first gripping surface 141; a grass-combing channel 152 is formed between the any two adjacent ones of the tooth units 151; the grass-combing channel 152 extends in a direction perpendicular to the length direction of the gripping portion 140; and the side of the gripping portion 140 facing towards the traveling surface M is configured as a second gripping surface 142, and the second gripping surface 142 is connected to the first gripping surface 141.

In an embodiment of the present application, the side of the gripping portion 140 facing towards the through-hole 130 is the inner wall surface of the through-hole 130 closer to the gripping portion 140. In other words, a user's hand passes through the through-hole 130 to grip the gripping portion 140, where the first gripping surface 141 may be flat, curved, or of another shape. In some examples, the first gripping surface 141 is flat, with a curved transition between the first gripping surface 141 and an adjacent gripping surface to facilitate gripping by users.

In an embodiment of the present application, the side of the gripping portion 140 facing towards the traveling surface M forms the second gripping surface 142. In other words, the tooth units 151 are arranged on the second gripping surface 142, with a grippable surface between any two adjacent ones of the tooth units 151, and the second gripping surface 142 may also be flat or curved.

In an embodiment of the present application, the first and second gripping surfaces 141, 142 may be smooth or textured to enhance friction, thereby improving gripping performance.

In an embodiment of the present application, a grass-combing channel 152 is formed between the any two adjacent ones of the tooth units 151, and when the lawn mower is performing a mowing operation, the grass-combing channel 152 enables the passage of grass, so that the tooth units 151 can comb through the grass; in addition, the inner wall of the grass-combing channel 152 is also configured as a part of the second gripping surface 142, and when the lawn mower needs to be moved, a user's fingers pass through the grass-combing channel 152, and the tooth units 151 can provide support for the user's fingers to improve gripping performance.

In a technical solution of the embodiments of the present application, a side of the gripping portion 140 corresponding to the through-hole 130 is configured as a first gripping surface 141, which is relatively flat and convenient for users to grip; a grass-combing channel 152 is formed between the any two adjacent ones of the tooth units 151, facilitating the passage of grass; the grass-combing channel 152 extends in a direction perpendicular to the length direction of the gripping portion 140, facilitating users to insert their fingers into the grass-combing channel 152 when they grip the gripping portion 140; and a side of the gripping portion 140 corresponding to the grass-combing channel 152 is configured as a second gripping surface 142, and the second gripping surface 142 is connected to the first gripping surface 141, thereby facilitating users to grip the gripping portion 140, improving the fit between users' palms and fingers and the gripping portion 140, and enhancing gripping performance.

Referring to FIGS. 1, 3, and 4, in some embodiments of the present application, the tooth units 151 are integrally formed with the gripping portion 140.

In an embodiment of the present application, integral forming refers to the formation of various parts of a structural member as an integral structure in a single pass, eliminating the need for additional assembly, and the integrally formed parts may be made of the same or different materials. Integral forming may be achieved through methods such as injection molding, compression molding, casting, or thermoforming, which is not limited in the embodiments of the present application.

In a technical solution of the embodiments of the present application, the integrally formed tooth units 151 and gripping portion 140 not only enhance structural integrity and strength but also optimizes center of gravity distribution; additionally, the tooth units 151 and the gripping portion 140 do not require separate installation onto the body 100, making assembly, disassembly, and maintenance more convenient; furthermore, since there is no assembly gap between the integrally formed tooth units 151 and gripping portion 140, debris is hard to accumulate, reducing wear and corrosion caused by accumulated debris to the tooth units 151 and the gripping portion 140, thereby extending their service lives and saving time for clearing the accumulated debris.

Referring to FIG. 1, in some embodiments of the present application, the lawn mower further includes a cutting assembly 200, and relative to the cutting assembly 200, the gripping portion 140 is located at a rear side of the body 100.

In an embodiment of the present application, the cutting assembly 200 is configured to cut and trim grass and may include a cutting disc provided with rotatable cutting blades, or the cutting assembly 200 may further include a trimmer line that cuts grass through rotation. Additionally, the cutting assembly 200 may further include a protective cover or the like.

In an embodiment of the present application, relative to the cutting assembly 200, the gripping portion 140 is closer to a rear edge of the body 100, and along the traveling direction X, a maximum gap between the gripping portion 140 and a rear end face of the body 100 is smaller than that between the cutting assembly 200 and the rear end face of the body 100. In other words, when the lawn mower performs a mowing operation, the grass is first cut by the cutting assembly 200 and then combed by the toothed structure 150 on the gripping portion 140.

In a technical solution of the embodiments of the present application, relative to the cutting assembly 200, the gripping portion 140 is located at the rear side of the body 100 so that the tooth units 151 on the gripping portion 140 can comb through the cut grass, thereby making the lawn more even and aesthetically pleasing and enhancing the aesthetic effect created by the lawn mower on the lawn.

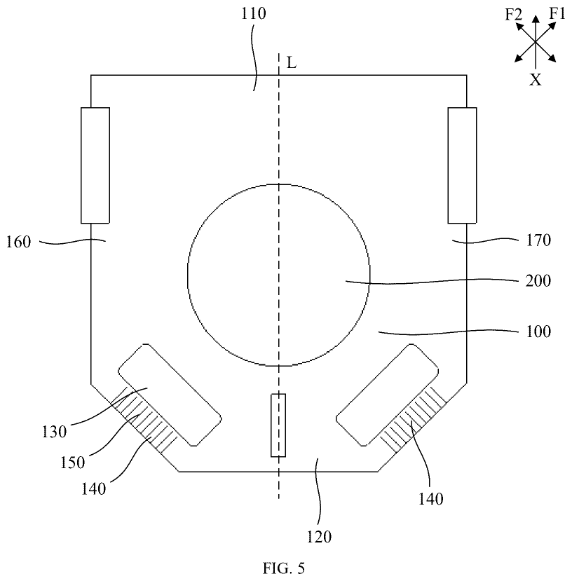

Referring to FIG. 5, in some embodiments of the present application, along a direction parallel to the traveling surface M and perpendicular to the traveling direction X, the body 100 includes a first side portion 160 and a second side portion 170; the number of the gripping portion 140 is two; and the two gripping portions 140 are respectively located at the first and second side portions 160, 170 of the body 100.

In an embodiment of the present application, the first and second side portions 160, 170 are arranged opposite to each other, with the opposing direction being perpendicular to the traveling direction X, and the first and second side portions 160, 170 may also be understood as the left and right side portions of the body 100. Correspondingly, the two gripping portions 140 are respectively located on the left and right sides of the rear-side portion 120 of the body 100.

In an embodiment of the present application, the number of the gripping portion 140 may be one or multiple, and the multiple includes two or more. The gripping portion 140 may be arranged at an edge of the body 100 parallel to the traveling direction X, or at an edge of the body 100 perpendicular to the traveling direction X, or at a corner of the body 100. For example, the gripping portion 140 is arranged on a diagonal line of the body 100. The multiple gripping portions 140 may be symmetrically or asymmetrically arranged at different positions of the body 100.

In a technical solution of the embodiments of the present application, the two gripping portions 140 are respectively located at the first and second side portions 160, 170 of the body 100, enabling users to choose one or both for operation as needed and enhancing operational convenience; additionally, the tooth units 151 on the two gripping portions 140 can separately comb through the grass passing through the first and second side portions 160, 170, thereby improving grass-combing uniformity.

Referring to FIG. 5, in some embodiments of the present application, the two gripping portions 140 are symmetrically arranged about a central axis L of the body 100 along the traveling direction X.

In an embodiment of the present application, the symmetrical arrangement of the two gripping portions 140 refers to that the structures thereof are mirror-symmetrical about a vertical plane where the central axis is located, with corresponding parts of the two gripping portions 140 maintaining equal perpendicular distances to the central axis L. For example, an included angle between the length direction of one of the two gripping portions 140 and the traveling direction X is 45°, while an included angle between the length direction of the other one of the two gripping portions 140 and the traveling direction X is 135°, with the tooth units 151 on the two gripping portions 140 also being symmetrically arranged about the central axis.

In a technical solution of the embodiments of the present application, the two symmetrically arranged gripping portions 140 optimize the center of gravity distribution of the body 100 and enable users to apply a force evenly, making it easier to lift the lawn mower; additionally, since the gripping portions 140 are symmetrically arranged, the tooth units 151 thereon are also arranged symmetrically about the central axis L, ensuring that the two toothed structures 150 can achieve consistent grass-combing performance.

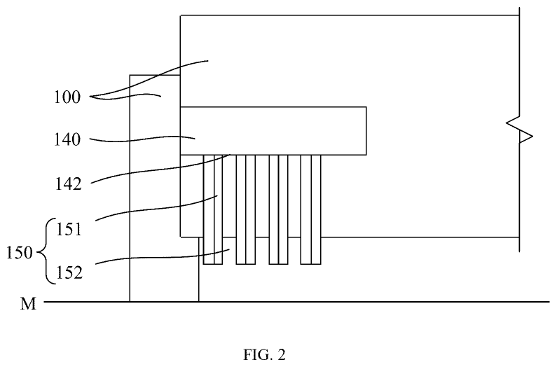

Referring to FIGS. 1 and 2, the lawn mower provided by the embodiments of the present application is capable of traveling along a traveling direction X on a traveling surface M and includes a body 100. The body 100 includes a front-side portion 110 and a rear-side portion 120 along the traveling direction X and is provided with a through-hole 130 arranged at the rear-side portion 120 of the body 100. A gripping portion 140 is formed between the through-hole 130 and an edge of the rear-side portion 120 of the body 100. The gripping portion 140 is a strip-shaped member, and a toothed structure 150 is arranged on a side of the gripping portion 140 facing towards the traveling surface M. A first included angle α is formed between a length direction of the strip-shaped member and the traveling direction X, and the first included angle α is greater than or equal to 30° and less than or equal to 60°.

In an embodiment of the present application, the body 100 may include a housing, a traveling mechanism, an energy supply mechanism, an electronic control assembly, etc., where the housing is configured to accommodate a cutting assembly 200 of the lawn mower; the traveling mechanism is arranged at the bottom of the housing and may include drive wheels, steering wheels, etc.; the energy supply mechanism and the electronic control assembly are arranged inside the housing for protection; the energy supply mechanism supplies energy to the cutting assembly 200, the traveling mechanism, etc.; and the electronic control assembly is configured to control the operation of the cutting assembly 200 and the traveling mechanism, and may also interact with users and communicate with external terminals.

In an embodiment of the present application, the front-side portion is arranged at the front side of the body 100 along the traveling direction X, and may be provided with structures such as an obstacle avoidance radar and an environmental monitoring camera; and the rear-side portion is arranged at the rear side of the body 100 along the traveling direction X, and may be provided with structures such as a navigation assembly and a charging assembly.

In an embodiment of the present application, the through-hole 130 may be a constant-diameter hole, tapered hole, or stepped hole, with its cross-sectional surface possibly being regularly shaped or irregularly shaped, such as circular, elliptical, race-track-shaped, triangular, rectangular, or trapezoidal. In some examples, the through-hole 130 is configured as an elliptical constant-diameter hole, with its longitudinal axis arranged perpendicular to the traveling surface M to facilitate the insertion of users' hands through the through-hole 130 to grip the gripping portion 140.

In an embodiment of the present application, the gripping portion 140 refers to a structure designed for manual gripping by users or mechanical gripping by robotic claws and is formed between the through-hole 130 and an edge of the rear-side portion 120 of the body 100. Specifically, both an inner wall on one side of the through-hole 130 and a surface of the body 100 that faces away from the inner wall of the through-hole 130 constitute the surface of the gripping portion 140. Taking manual gripping by users as an example, when a user inserts partial fingers through the through-hole 130, both fingers and palms encircle the gripping portion 140, enabling multi-directional force application on the gripping portion 140 so that the user can lift the lawn mower via the gripping portion 140.

In an embodiment of the present application, the strip-shaped member refers to an elongated structural member, which may be configured as a polyhedral structure, such as a right prism (with straight edges and planar faces) or a curved prism (with curved edges and arcuate surfaces), or as a cylinder or elliptical cylinder. In all configurations, the length direction of the strip-shaped member is parallel to the central axis of either the prism or the cylinder.

In an embodiment of the present application, the toothed structure 150 refers to a configuration including multiple concave portions and convex portions alternately arranged in sequence, where the convex portions may be referred to as tooth units 151, and the concave portions formed between two adjacent tooth units 151 may function as channels to enable the passage of other objects. In some examples, the toothed structure 150 serves as a grass-combing mechanism, where its concave portions form channels for the passage of grass, thereby achieving grass combing.

In an embodiment of the present application, a user grips the strip-shaped member to apply a force to the lawn mower, where the direction of the interaction force between the user and the lawn mower is perpendicular to the length direction of the strip-shaped member. By setting the first included angle α within a reasonable range, the direction of the interaction force between the user and the lawn mower can pass through or approach the central area of the lawn mower. For example, an axis perpendicular to the strip-shaped member is the diagonal line of the body 100.

In an embodiment of the present application, the closer the first included angle α between the length direction of the strip-shaped member and the traveling direction X is to 30°, the closer the gripping portion 140 is to the central axis of the body 100 along the traveling direction X, and the closer the direction of the interaction force between a user and the lawn mower is to the rear-side portion 120 of the body 100, thereby helping shift the weight distribution of the lawn mower toward the rear and reducing drifting and slipping of the lawn mower during operation; when the first included angle α approaches 45°, the axis of the interaction force between the user and the lawn mower when the user grips the gripping portion 140 aligns more closely with the lawn mower's center of gravity, making it easier for the user to lift the lawn mower; and when the first included angle α is closer to 60°, the first extension direction F1 of the tooth units 151 remains perpendicular to the length direction of the gripping portion 140 while being more aligned with the traveling direction X, which not only facilitates the user to grip the gripping portion 140 but also improves the passage of grass through gaps between the tooth units 151.

In an embodiment of the present application, the first included angle α is greater than or equal to 30° and less than or equal to 60°. In some examples, the first included angle α is greater than or equal to 30° and less than or equal to 50°, such as 30°, 35°, 40°, 45°, or 50°; in other examples, the first included angle α is greater than or equal to 40° and less than or equal to 60°, such as 40°, 45°, 55°, or 60°.

In a technical solution of the embodiments of the present application, the body 100 of the lawn mower includes a front-side portion 110 and a rear-side portion 120 which is provided with a through-hole 130, and a gripping portion 140 for users to grip is formed between the through-hole 130 and an edge of the rear-side portion 120. A toothed structure 150 including multiple tooth units 151 is arranged on a side of the gripping portion 140 facing towards the traveling surface M. The tooth units 151 can function as grass-combing teeth and form channels for users to grip, thereby enhancing stability during users' gripping of the gripping portion 140.

Since the toothed structure 150 is integrated into the gripping portion 140, the toothed structure 150 and the gripping portion 140 can be arranged on the body 100 as a whole, enhancing structural integrity; additionally, it is not easy for debris such as mud and sand to accumulate between the toothed structure 150 and the gripping portion 140, reducing wear and corrosion caused by the accumulated debris to the tooth units 151 and the gripping portion 140. This configuration not only extends the service lives of both the tooth units 151 and the gripping portion 140 but also saves time for clearing the accumulated debris, thereby improving the user experience of the lawn mower.

The first included angle α between the length direction of the strip-shaped member and the traveling direction X is set within a reasonable range, not only meeting the arrangement requirements of the gripping portion 140 at different positions on the body 100 but also facilitating users to lift the lawn mower through the gripping portion 140.

Referring to FIG. 1, in some embodiments of the present application, the toothed structure 150 includes multiple tooth units 151; a projection of each of the tooth units 151 on the traveling surface is strip-shaped with a first extension direction F1; an included angle between the first extension direction F1 and the length direction of the gripping portion 140 is greater than or equal to 75° and less than or equal to 105°, and an included angle between the first extension direction F1 and the traveling direction X is unequal to 90°; and the multiple tooth units 151 are spaced apart along the length direction of the gripping portion 140, and projections of any two adjacent ones of the tooth units 151 on a plane perpendicular to the length direction of the gripping portion 140 at least partially overlap.

In an embodiment of the present application, the included angle between the first extension direction F1 and the length direction of the gripping portion 140 forms a second included angle β, and when the second included angle β approaches 90°, the extension direction of the tooth units 151 aligns more closely with the natural finger placement when users grip the gripping portion 140, thereby facilitating users to grip the gripping portion 140; conversely, the second included angle β approaching either 75° or 105° facilitates the forming of an appropriate included angle between the extension direction of the tooth units 151 and the traveling direction X, thereby improving grass-combing performance.

In an embodiment of the present application, the second included angle β is greater than or equal to 75° and less than or equal to 105°. In some examples, the second included angle β is greater than or equal to 75° and less than or equal to 90°, such as 75°, 80°, 85°, or 90°; in other examples, the second included angle β is greater than or equal to 85° and less than or equal to 95°, such as 85°, 90°, or 95°; in further examples, the second included angle β is greater than or equal to 90° and less than or equal to 105°, such as 90°, 95°, 100°, or 105°.

In an embodiment of the present application, the included angle between the first extension direction F1 and the traveling direction X forms a third included angle γ, where the third included angle γ is unequal to 90°. For example, the third included angle γ may be greater than or equal to 0°and less than 90°, such as 0°, 30°, 45°, 60°, or 75°; or, the third included angle γ may be greater than 90° and less than or equal to 180°, such as 105°, 120°, 150°, or 180°. It can be understood that when the third included angle γ is 0° or 180°, the extension direction of the tooth units 151 is parallel to the traveling direction X.

In an embodiment of the present application, the tooth units 151 may be configured as plate-shaped structures, rod-shaped structures, or similar structures, with the multiple tooth units 151 possibly having the same or different configurations, and the multiple tooth units 151 are spaced apart along the length direction of the gripping portion 140 at a consistent or variable spacing between any two adjacent ones of the tooth units 151. In some examples, the multiple tooth units 151 have the same configuration and are spaced apart at a consistent spacing.

In an embodiment of the present application, projections of any two adjacent ones of the tooth units 151 on a plane perpendicular to the length direction of the gripping portion 140 (i.e., viewed along the length direction of the gripping portion 140) at least partially overlap. It may be that one of the any two adjacent ones of the tooth units 151 is dimensionally smaller than the other; or, one of the any two adjacent ones of the tooth units 151 is closer to an edge of the body 100 while the other is closer to the through-hole 130, with the two not being completely staggered; still or, the any two adjacent ones of the tooth units 151 have the same configuration and dimensions with fully overlapping projections.

In a technical solution of the embodiments of the present application, each of the tooth units 151 extends along the first extension direction F1, and the included angle between the first extension direction F1 and the length direction of the gripping portion 140 falls within a reasonable range. The extension direction of the tooth units 151 aligns with the natural finger placement when users grip the gripping portion 140, thereby facilitating gripping by users and the forming of an appropriate included angle between the extension direction of the tooth units 151 and the traveling direction X, and improving grass-combing performance.

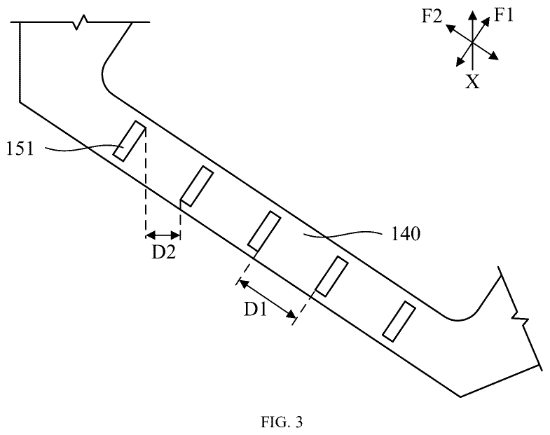

Referring to FIG. 3, in some embodiments of the present application, there is a first spacing D1 between the any two adjacent ones of the tooth units 151, and a minimum gap between orthographic projections of the any two adjacent ones of the tooth units 151 on a plane perpendicular to the traveling direction X forms a second spacing D2, where a ratio of the first spacing D1 to the second spacing D2 is greater than 1 and less than 5.

In an embodiment of the present application, the minimum gap between orthographic projections of the any two adjacent ones of the tooth units 151 specifically refers to the spacing between non-overlapping projections thereof when viewed along the traveling direction X. It may be also understood as, with the any two adjacent ones of the tooth units 151 each including a first end closer to the through-hole 130 and a second end closer to the edge of the body 100, the spacing between the first end of one tooth unit 151 and the second end of the other tooth unit 151 along the length direction of the gripping portion 140.

In an embodiment of the present application, a smaller ratio of the first spacing D1 to the second spacing D2 indicates that the extension direction of the tooth units 151 is more aligned with the traveling direction X, facilitating the passage of grass through gaps between adjacent tooth units 151 to enhance grass-combing performance; conversely, a larger ratio of the first spacing D1 to the second spacing D2 indicates wider gaps between adjacent tooth units 151, facilitating finger insertion for users to improve users' experience when gripping the gripping portion 140.

In an embodiment of the present application, the ratio of the first spacing D1 to the second spacing D2 is greater than 1 and less than 5. In some examples, the ratio of the first spacing D1 to the second spacing D2 is greater than 1 and less than or equal to 3, such as 1.1, 1.5, 2.0, 2.5, or 3; in other examples, the ratio of the first spacing D1 to the second spacing D2 is greater than or equal to 2 and less than or equal to 4, such as 2.0, 2.5, 3.0, 3.5, or 4.0; and in further examples, the ratio of the first spacing D1 to the second spacing D2 is greater than or equal to 3 and less than 5, such as 3.0, 3.5, 4.0, 4.5, or 4.9.

In a technical solution of the embodiments of the present application, the ratio of the first spacing D1 between the any two adjacent ones of the tooth units 151 to the second spacing D2 is set within a reasonable range, facilitating not only the passage of grass through gaps between adjacent tooth units 151 to enhance grass-combing performance but also leaving enough gaps for finger insertion to improve users' experience when gripping the gripping portion 140.

Referring to FIG. 4, in some embodiments of the present application, a side of the gripping portion 140 facing towards the through-hole 130 is configured as a first gripping surface 141; a grass-combing channel 152 is formed between the any two adjacent ones of the tooth units 151; the grass-combing channel 152 extends in a direction perpendicular to the length direction of the gripping portion 140; and the side of the gripping portion 140 facing towards the traveling surface M is configured as a second gripping surface 142, and the second gripping surface 142 is connected to the first gripping surface 141.

In an embodiment of the present application, the side of the gripping portion 140 facing towards the through-hole 130 is the inner wall surface of the through-hole 130 closer to the gripping portion 140. In other words, a user's hand passes through the through-hole 130 to grip the gripping portion 140, where the first gripping surface 141 may be flat, curved, or of another shape. In some examples, the first gripping surface 141 is flat, with a curved transition between the first gripping surface 141 and an adjacent gripping surface to facilitate gripping by users.

In an embodiment of the present application, the side of the gripping portion 140 facing towards the traveling surface M forms the second gripping surface 142. In other words, the tooth units 151 are arranged on the second gripping surface 142, with a grippable surface between any two adjacent ones of the tooth units 151, and the second gripping surface 142 may also be flat or curved.

In an embodiment of the present application, the first and second gripping surfaces 141, 142 may be smooth or textured to enhance friction, thereby improving gripping performance.

In an embodiment of the present application, a grass-combing channel 152 is formed between the any two adjacent ones of the tooth units 151, and when the lawn mower is performing a mowing operation, the grass-combing channel 152 enables the passage of grass, so that the tooth units 151 can comb through the grass; in addition, the inner wall of the grass-combing channel 152 is also configured as a part of the second gripping surface 142, and when the lawn mower needs to be moved, a user's fingers pass through the grass-combing channel 152, and the tooth units 151 can provide support for the user's fingers to improve gripping performance.

In a technical solution of the embodiments of the present application, a side of the gripping portion 140 corresponding to the through-hole 130 is configured as a first gripping surface 141, which is relatively flat and convenient for users to grip; a grass-combing channel 152 is formed between the any two adjacent ones of the tooth units 151, facilitating the passage of grass; the grass-combing channel 152 extends in a direction perpendicular to the length direction of the gripping portion 140, facilitating users to insert their fingers into the grass-combing channel 152 when they grip the gripping portion 140; and a side of the gripping portion 140 corresponding to the grass-combing channel 152 is configured as a second gripping surface 142, and the second gripping surface 142 is connected to the first gripping surface 141, thereby facilitating users to grip the gripping portion 140, improving the fit between users' palms and fingers and the gripping portion 140, and enhancing gripping performance.

Referring to FIGS. 1, 3, and 4, in some embodiments of the present application, the tooth units 151 are integrally formed with the gripping portion 140.

In an embodiment of the present application, integral forming refers to the formation of various parts of a structural member as an integral structure in a single pass, eliminating the need for additional assembly, and the integrally formed parts may be made of the same or different materials. Integral forming may be achieved through methods such as injection molding, compression molding, casting, or thermoforming, which is not limited in the embodiments of the present application.

In a technical solution of the embodiments of the present application, the integrally formed tooth units 151 and gripping portion 140 not only enhance structural integrity and strength but also optimizes centers of gravity of both the tooth units and the gripping portion; additionally, the tooth units 151 and the gripping portion 140 do not require separate installation onto the body 100, making assembly, disassembly, and maintenance more convenient; furthermore, since there is no assembly gap between the integrally formed tooth units 151 and gripping portion 140, debris is hard to accumulate, reducing wear and corrosion caused by accumulated debris to the tooth units 151 and the gripping portion 140, thereby extending their service lives and saving time for clearing the accumulated debris.

Referring to FIGS. 1 and 5, in some embodiments of the present application, the lawn mower further includes a cutting assembly 200, and relative to the cutting assembly 200, the gripping portion 140 is located at a rear side of the body 100.

In an embodiment of the present application, the cutting assembly 200 is configured to cut and trim grass and may include a cutting disc provided with rotatable cutting blades, or the cutting assembly 200 may further include a trimmer line that cuts grass through rotation. Additionally, the cutting assembly 200 may further include a protective cover or the like.

In an embodiment of the present application, relative to the cutting assembly 200, the gripping portion 140 is closer to a rear edge of the body 100, and along the traveling direction X, a maximum gap between the gripping portion 140 and a rear end face of the body 100 is smaller than that between the cutting assembly 200 and the rear end face of the body 100. In other words, when the lawn mower performs a mowing operation, the grass is first cut by the cutting assembly 200 and then combed by the toothed structure 150 on the gripping portion 140.

In a technical solution of the embodiments of the present application, relative to the cutting assembly 200, the gripping portion 140 is located at the rear side of the body 100 so that the tooth units 151 on the gripping portion 140 can comb through the cut grass, thereby making the lawn more even and aesthetically pleasing and enhancing the aesthetic effect created by the lawn mower on the lawn.

Referring to FIG. 5, in some embodiments of the present application, along a direction parallel to the traveling surface M and perpendicular to the traveling direction X, the body 100 includes a first side portion 160 and a second side portion 170; the number of the gripping portion 140 is two; and the two gripping portions 140 are respectively located at the first and second side portions 160, 170 of the body 100.

In an embodiment of the present application, the first and second side portions 160, 170 are arranged opposite to each other, with the opposing direction being perpendicular to the traveling direction X, and the first and second side portions 160, 170 may also be understood as the left and right side portions of the body 100. Correspondingly, the two gripping portions 140 are respectively located on the left and right sides of the rear-side portion 120 of the body 100.

In an embodiment of the present application, the number of the gripping portion 140 may be one or multiple, and the multiple includes two or more. The gripping portion 140 may be arranged at an edge of the body 100 parallel to the traveling direction X, or at an edge of the body 100 perpendicular to the traveling direction X, or at a corner of the body 100. For example, the gripping portion 140 is arranged on a diagonal line of the body 100. The multiple gripping portions 140 may be symmetrically or asymmetrically arranged at different positions of the body 100.

In a technical solution of the embodiments of the present application, the two gripping portions 140 are respectively located at the first and second side portions 160, 170 of the body 100, enabling users to choose one or both for operation as needed and enhancing operational convenience; additionally, the tooth units 151 on the two gripping portions 140 can separately comb through the grass passing through the first and second side portions 160, 170, thereby improving grass-combing uniformity.

Referring to FIG. 5, in some embodiments of the present application, the two gripping portions 140 are symmetrically arranged about a central axis L of the body 100 along the traveling direction X.

In an embodiment of the present application, the symmetrical arrangement of the two gripping portions 140 refers to that the structures thereof are mirror-symmetrical about a vertical plane where the central axis is located, with corresponding parts of the two gripping portions 140 maintaining equal perpendicular distances to the central axis L. For example, an included angle between the length direction of one of the two gripping portions 140 and the traveling direction X is 45°, while an included angle between the length direction of the other one of the two gripping portions 140 and the traveling direction X is 135°, with the tooth units 151 on the two gripping portions 140 also being symmetrically arranged about the central axis.

In a technical solution of the embodiments of the present application, the two symmetrically arranged gripping portions 140 optimize the center of gravity distribution of the body 100 and enable users to apply a force evenly, making it easier to lift the lawn mower; additionally, since the gripping portions 140 are symmetrically arranged, the tooth units 151 thereon are also arranged symmetrically about the central axis L, ensuring that the two toothed structures 150 can achieve consistent grass-combing performance.

In a possible embodiment of the present application, the lawn mower is capable of moving along a traveling direction X on a traveling surface M to perform mowing operations. The lawn mower includes a body 100, where the body 100 includes a front-side portion and a rear-side portion, and the rear-side portion 120 is provided with a through-hole 130 arranged at a corner of the body 100. In other words, the through-hole 130 is arranged at a rear side of the body 100. A gripping portion 140 for users to grip is formed between the through-hole 130 and an edge of the rear-side portion 120, enabling users to lift the lawn mower. The gripping portion 140 is a strip-shaped member, and an included angle of 45° is formed between a length direction of the gripping portion 140 and the traveling direction X. In other words, when a user lifts the lawn mower through the gripping portion 140, an included angle is formed between the axis of the interaction force between the user and the gripping portion 140 and the traveling direction X.

A toothed structure 150 including multiple tooth units 151 is arranged on a side of the gripping portion 140 facing towards the traveling surface M, and the tooth structure 150 is integrally formed with the gripping portion 140. An included angle of 90° is formed between an extension direction of the multiple tooth units 151 and the length direction of the gripping portion 140. Projections of any two adjacent ones of the tooth units 151 on a plane perpendicular to the length direction of the gripping portion 140 overlap. A grass-combing channel 152 is formed between the any two adjacent ones of the tooth units 151, where the grass-combing channel 152 is configured to enable both the passage of grass for lawn grooming and beautification and the insertion of users' fingers to grip the gripping portion 140; and the tooth units 151 can further provide support for users' fingers to enhance gripping stability.

The serial numbers of the foregoing embodiments of the present application are only for description and do not imply a preference among the embodiments. The above-described embodiments are only the preferred embodiments of the present application and do not limit the patent scope of the present application. Any equivalent structure or process transformation made according to the specification and the content of the accompanying drawings of the present application or directly or indirectly used in other related technical fields is included in the patent protection scope of the present application in the same way.

What is claimed is:

1. A lawn mower, capable of traveling along a traveling direction on a traveling surface and comprising a body, wherein
the body comprises a front-side portion and a rear-side portion along the traveling direction and is provided with a through-hole arranged at the rear-side portion of the body, and a gripping portion is formed between the through-hole and an edge of the rear-side portion of the body;
the gripping portion is a strip-shaped member, and a toothed structure comprising a plurality of tooth units is arranged on a side of the gripping portion facing towards the traveling surface;
a projection of each of the tooth units on the traveling surface is strip-shaped with a first extension direction, an included angle between the first extension direction and a length direction of the gripping portion is greater than or equal to 75° and less than or equal to 105°, and an included angle between the first extension direction and the traveling direction is unequal to 90°; and the plurality of tooth units are spaced apart along the length direction of the gripping portion, and projections of any two adjacent ones of the tooth units on a plane perpendicular to the length direction of the gripping portion at least partially overlap; and
there is a first spacing D1 between the any two adjacent ones of the tooth units along the length direction of the gripping portion, and a minimum gap between orthographic projections of the any two adjacent ones of the tooth units on a plane perpendicular to the traveling direction forms a second spacing D2, wherein a ratio of the first spacing D1 to the second spacing D2 is greater than 1 and less than 5.

2. The lawn mower of claim 1, wherein a first included angle is formed between a length direction of the strip-shaped member and the traveling direction, and the first included angle is greater than or equal to 30° and less than or equal to 60°.

3. The lawn mower of claim 1, wherein a side of the gripping portion facing towards the through-hole is configured as a first gripping surface; and
a grass-combing channel is formed between the any two adjacent ones of the tooth units; the grass-combing channel extends in a direction perpendicular to the length direction of the gripping portion; and the side of the gripping portion facing towards the traveling surface is configured as a second gripping surface, and the second gripping surface is connected to the first gripping surface.

4. The lawn mower of claim 1, wherein the tooth units are integrally formed with the gripping portion.

5. The lawn mower of claim 1, wherein the lawn mower further comprises a cutting assembly, and relative to the cutting assembly, the gripping portion is located at a rear side of the body.

6. The lawn mower of claim 1, wherein along a direction parallel to the traveling surface and perpendicular to the traveling direction, the body comprises a first side portion and a second side portion; the number of the gripping portion is two; and the two gripping portions are respectively located at the first and second side portions of the body.

7. The lawn mower of claim 6, wherein the two gripping portions are symmetrically arranged about a central axis of the body along the traveling direction.

8. A lawn mower, capable of traveling along a traveling direction on a traveling surface and comprising a body, wherein
the body comprises a front-side portion and a rear-side portion along the traveling direction and is provided with a through-hole arranged at the rear-side portion of the body, and a gripping portion is formed between the through-hole and an edge of the rear-side portion of the body;
a toothed structure is arranged on a side of the gripping portion facing towards the traveling surface, and the gripping portion is a strip-shaped member; and
a first included angle is formed between a length direction of the strip-shaped member and the traveling direction, and the first included angle is greater than or equal to 30° and less than or equal to 60°.

9. The lawn mower of claim 8, wherein the toothed structure comprises a plurality of tooth units; a projection of each of the tooth units on the traveling surface is strip-shaped with a first extension direction; an included angle between the first extension direction and the length direction of the gripping portion is greater than or equal to 75° and less than or equal to 105°, and an included angle between the first extension direction and the traveling direction is unequal to 90°; and
the plurality of tooth units are spaced apart along the length direction of the gripping portion, and projections of any two adjacent ones of the tooth units on a plane perpendicular to the length direction of the gripping portion at least partially overlap.

10. The lawn mower of claim 9, wherein there is a first spacing D1 between the any two adjacent ones of the tooth units along the length direction of the gripping portion, and a minimum gap between orthographic projections of the any two adjacent ones of the tooth units on a plane perpendicular to the traveling direction forms a second spacing D2, wherein a ratio of the first spacing D1 to the second spacing D2 is greater than 1 and less than 5.

11. The lawn mower of claim 9, wherein a side of the gripping portion facing towards the through-hole is configured as a first gripping surface; and
a grass-combing channel is formed between the any two adjacent ones of the tooth units; the grass-combing channel extends in a direction perpendicular to the length direction of the gripping portion; and the side of the gripping portion facing towards the traveling surface is configured as a second gripping surface, and the second gripping surface is connected to the first gripping surface.

12. The lawn mower of claim 9, wherein the tooth units are integrally formed with the gripping portion.

13. The lawn mower of claim 8, wherein the lawn mower further comprises a cutting assembly, and relative to the cutting assembly, the gripping portion is closer to the rear-side portion of the body.

14. The lawn mower of claim 8, wherein along a direction parallel to the traveling surface and perpendicular to the traveling direction, the body comprises a first side portion and a second side portion; the number of the gripping portion is two; and the two gripping portions are respectively located at the first and second side portions of the body.

15. The lawn mower of claim 14, wherein the two gripping portions are symmetrically arranged about a central axis of the body along the traveling direction.

16. A lawn mower, capable of traveling along a traveling direction on a traveling surface and comprising a body, wherein
the body comprises a front-side portion and a rear-side portion along the traveling direction and is provided with a through-hole arranged at the rear-side portion of the body, and a gripping portion is formed between the through-hole and an edge of the rear-side portion of the body;
the gripping portion is a strip-shaped member, and a toothed structure comprising a plurality of tooth units is arranged on a side of the gripping portion facing towards the traveling surface;
a projection of each of the tooth units on the traveling surface is strip-shaped with a first extension direction; an included angle between the first extension direction and a length direction of the gripping portion is greater than or equal to 75° and less than or equal to 105°, and an included angle between the first extension direction and the traveling direction is unequal to 90°; and the plurality of tooth units are spaced apart along the length direction of the gripping portion, and projections of any two adjacent ones of the tooth units on a plane perpendicular to the length direction of the gripping portion at least partially overlap; and
an included angle between the length direction of the gripping portion and the traveling direction is greater than 0°.

17. The lawn mower of claim 16, wherein there is a first spacing D1 between the any two adjacent ones of the tooth units along the length direction of the gripping portion, and a minimum gap between orthographic projections of the any two adjacent ones of the tooth units on a plane perpendicular to the traveling direction forms a second spacing D2, wherein a ratio of the first spacing D1 to the second spacing D2 is greater than 1 and less than 5.
